(19) United States
(12) Patent Application Publication
(10) Pub. No.: US 2017/0248943 A1
(43) Pub. Date: Aug. 31, 2017

(54) METHOD AND SYSTEM FOR DETERMINING SAMPLING PLAN FOR INSPECTION OF COMPOSITE COMPONENTS

(71) Applicant: BOMBARDIER INC., Dorval (CA)

(72) Inventor: Yan GALARNEAU, Montreal (CA)

(21) Appl. No.: 15/507,437

(22) PCT Filed: Aug. 27, 2015
(86) PCT No.: PCT/IB2015/056511

§ 371 Date: Feb. 28, 2017

Related U.S. Application Data
(60) Provisional application No. 62/044,618, filed on Sep. 2, 2014.

(51) Int. Cl. G05B 23/02

(52) U.S. Cl. CPC G05B 23/0213; G05B 23/0216

(57) ABSTRACT

There is described a method and system for determining a sampling plan using a statistical analysis of different regions of at least one component and determining a level of performance for each of the regions. Subsequent components are then inspected using the sampling plan. Results from the inspection may be used to update and/or modify the sampling plan in a feedback loop.

### CROSS-REFERENCE TO RELATED APPLICATIONS

This application claims priority under 35 U.S.C. 119(e) to U.S. application No. 62/044,618 filed Sep. 2, 2014, entitled “Method and System for Determining Sampling Plan for Inspection of Composite Components”, the entire contents of which are hereby incorporated by reference.

### TECHNICAL FIELD

The present invention relates to the field of inspecting composite components fabricated by automated manufacturing processes and more particularly, to a dynamic method of determining a sampling plan for the inspection of composite components.

### BACKGROUND OF THE ART

Inspecting the dimensional requirements of a manufactured component is an important part of the manufacturing process. Manual inspection of every component is extremely time consuming. Sampling is thus used to lower the costs and reduce the overall time needed for inspection. Acceptance sampling, which consists of sampling only one or two components of a batch to accept or reject the entire batch, is used to determine if a production lot of material meets the specification. However, in certain industries, acceptance sampling is incompatible with the nature of the components. In some instances, rejecting an entire batch based on one or two samples is cost-prohibitive. In other instances, accepting an entire batch based on one or two components does not meet industry standards with regards to safety requirements.

There is therefore a need to improve the inspection phase of the manufacturing process for certain components.

### SUMMARY

There is described a method and system for determining a sampling plan using a statistical analysis of different regions of at least one component and determining a level of performance for each of the regions. Subsequent components are then inspected using the sampling plan. Results from the inspection may be used to update and/or modify the sampling plan in a feedback loop.

In accordance with a first broad aspect, there is provided a computer implemented method for determining a sampling plan for inspection of composite components, the composite components each comprising at least one ply comprising a plurality of regions, each one of the regions having a plurality of fibers. The method comprises receiving deviation data for all of the regions of at least one ply of at least a first composite component, the deviation data corresponding to a deviation of a measured value from a nominal value for a given fiber; applying a statistical model to the deviation data to obtain a performance indicator for each one of the regions and generating a mapping of performance indicators for the at least one ply; and establishing the sampling plan for inspection of the at least one ply of at least one subsequent composite component as a function of the mapping of performance indicators.

In some embodiments of the method, establishing the sampling plan comprises assigning a sampling criteria to each of the performance indicators, the sampling criteria being indicative of how many regions having a given performance indicator are to be inspected.

In some embodiments of the method, the sampling criteria is indicative of how many regions from one of the at least one ply, the at least one subsequent composite component, and a plurality of subsequent composite components, are to be inspected.

In some embodiments of the method; establishing the sampling plan comprises establishing a first sampling plan for a first ply as a function of a first sampling criteria, and establishing a second sampling plan for a second ply as a function of a second sampling criteria different from the first sampling criteria.

In some embodiments of the method; establishing the sampling plan comprises establishing a first sampling plan for a first subsequent component as a function of a first sampling criteria, and establishing a second sampling plan for a second subsequent component as a function of a second sampling criteria different from the first sampling criteria.

In some embodiments of the method, establishing the sampling plan further comprises selecting regions for inspection as a function of the performance indicators and the sampling criteria.

In some embodiments of the method, applying a statistical model comprises using at least three levels of performance indicators, the at least three levels comprising a lowest level of performance, an intermediate level of performance, and a highest level of performance.

In some embodiments of the method, selecting regions comprises selecting all regions of the lowest level and selecting some regions of the intermediate level.

In some embodiments of the method, selecting regions comprises selecting a number of regions of the highest level that is less than a number of selected regions of the intermediate level.

In some embodiments, the method further comprises receiving updated deviation data of the selected regions from inspection of the at least one subsequent composite component; applying the statistical model to the updated deviation data of the selected regions to obtain updated performance indicators for the selected regions; and generating an updated mapping of performance indicators with the updated performance indicators.

In some embodiments, the method further comprises receiving updated deviation data of the selected regions from inspection of the at least one subsequent composite component; applying the statistical model to the updated deviation data of the selected regions to obtain updated performance indicators for the selected regions; and generating an updated mapping of performance indicators with the updated performance indicators.

In some embodiments, the method further comprises comparing the updated performance indicators of the selected regions with the performance indicators for corresponding regions; selecting for inspection regions adjacent to a selected region for which the updated performance indicator is lower than the performance indicator; receiving deviation data for the adjacent regions; and quantifying a degradation of a manufacturing process using the deviation data from the adjacent regions.

In some embodiments of the method, receiving deviation data comprises receiving measurement data for at least one of the fibers of a region, for all regions of the at least one ply, and determining the deviation data from the measurement data.

In some embodiments, the method further comprises receiving a signal indicative of a change in a manufacturing process of the composite components, and updating the statistical model to reflect the change.

In some embodiments of the method, the signal is indicative of a maintenance of equipment used in the manufacturing process.

In some embodiments of the method, receiving deviation data for all of the regions of the at least one ply of at least a first composite component comprises receiving deviation data for a plurality of composite components, and wherein mapping the performance indicators comprises mapping averaged performance indicators for the plurality of composite components.

In some embodiments of the method, the deviation data corresponds to measurements of at least one of the fibers of a given region.

In accordance with another broad aspect, there is provided system for determining a sampling plan for inspection of composite components, the composite components each comprising at least one ply comprising a plurality of regions, each one of the regions having a plurality of fibers. The system comprises a memory, a processor, and at least one application stored in the memory and executable by the processor. The application is executable for receiving deviation data for all of the regions of at least one ply of at least a first composite component, the deviation data corresponding to a deviation of a measured value from a nominal value for a given fiber; applying a statistical model to the deviation data to obtain a performance indicator for each one of the regions and generating a mapping of performance indicators for the at least one ply; and establishing the sampling plan for inspection of the at least one ply of at least one subsequent composite component as a function of the mapping of performance indicators.

In some embodiments of the system; establishing the sampling plan comprises assigning a sampling criteria to each of the performance indicators, the sampling criteria being indicative of how many regions having a given performance indicator are to be inspected.

In some embodiments of the system, the sampling criteria is indicative of how many regions from one of the at least one ply, the at least one subsequent composite component, and a plurality of subsequent composite components, are to be inspected.

In some embodiments of the system; establishing the sampling plan comprises establishing a first sampling plan for a first ply as a function of a first sampling criteria, and establishing a second sampling plan for a second ply as a function of a second sampling criteria different from the first sampling criteria.

In some embodiments of the system, establishing the sampling plan comprises establishing a first sampling plan for a first subsequent component as a function of a first sampling criteria, and establishing a second sampling plan for a second subsequent component as a function of a second sampling criteria different from the first sampling criteria.

In some embodiments of the system, establishing the sampling plan further comprises selecting regions for inspection as a function of the performance indicators and the sampling criteria.

In some embodiments of the system, applying a statistical model comprises using at least three levels of performance indicators, the at least three levels comprising a lowest level of performance, an intermediate level of performance, and a highest level of performance.

In some embodiments of the system, selecting regions comprises selecting all regions of the lowest level and selecting some regions of the intermediate level.

In some embodiments of the system, selecting regions comprises selecting a number of regions of the highest level that is less than a number of selected regions of the intermediate level.

In some embodiments of the system, the application is further configured for receiving updated deviation data of the selected regions from inspection of the at least one subsequent composite component; applying the statistical model to the updated deviation data of the selected regions to obtain updated performance indicators for the selected regions; and generating an updated mapping of performance indicators with the updated performance indicators.

In some embodiments of the system, the application is further configured for comparing the updated performance indicators of the selected regions with the performance indicators for corresponding regions; selecting for inspection regions adjacent to a selected region for which the updated performance indicator is lower than the performance indicator; receiving deviation data for the adjacent regions; and quantifying a degradation of a manufacturing process using the deviation data from the adjacent regions.

In some embodiments of the system, receiving deviation data comprises receiving measurement data for at least one of the fibers of a region, for all regions of the at least one ply, and determining the deviation data from the measurement data.

In some embodiments of the system, the application is further configured for receiving a signal indicative of a change in a manufacturing process of the composite components, and updating the statistical model to reflect the change.

In some embodiments of the system, the signal is indicative of a maintenance of equipment used in the manufacturing process.

In some embodiments of the system, receiving deviation data for all of the regions of the at least one ply of at least a first composite component comprises receiving deviation data for a plurality of composite components, and wherein mapping the performance indicators comprises mapping averaged performance indicators for the plurality of composite components.

In some embodiments of the system, the deviation data corresponds to measurements of at least one of the fibers of a given region.

In accordance with yet another broad aspect, there is provided a computer readable medium having stored thereon program code executable by a processor for determining a sampling plan for inspection of composite components, the composite components each comprising at least one ply comprising a plurality of regions, each one of the regions having a plurality of fibers. The program code is executable for receiving deviation data for all of the regions of at least one ply of at least a first composite component, the deviation data corresponding to a deviation of a measured value from a nominal value for a given fiber; applying a statistical model to the deviation data to obtain a performance indicator for each one of the regions and generating a mapping of performance indicators for the at least one ply; and establishing the sampling plan for inspection of the at least one ply of at least one subsequent composite component as a function of the mapping of performance indicators.

In accordance with another broad aspect, there is provided a computer-implemented method for guiding inspection of at least one ply of a composite component. The method comprises receiving a mapping of performance indicators and a sampling criteria associated with the at least one ply, each one of the performance indicators corresponding to a region of the at least one ply, each region comprising a plurality of fibers, the sampling criteria being indicative of how many regions having a given performance indicator are to be inspected; selecting regions of the at least one ply for inspection as a function of the performance indicators and the sampling criteria; and displaying on a graphical user interface an identification of selected regions of the at least one ply for inspection.

In some embodiments of the method, displaying on a graphical user interface selected regions for inspection comprises displaying a graphical identification of the selected regions of the at least one ply for inspection.

In some embodiments, the method further comprises receiving, via a user actionable object on the graphical user interface, an indication that at least one selected region of the at least one ply for inspection has been inspected.

In accordance with yet another broad aspect, there is provided a graphical user interface for guiding inspection of a composite component having at least a first ply and a second ply. The graphical user interface comprises an information area displaying an identification of a first set of regions from the first ply, selected for inspection of the first ply; and an actionable object responsive to user input for receiving confirmation that the first set of regions have been inspected; wherein upon receipt of the confirmation, the information area is updated to display an identification of a second set of regions from the second ply different from the first set of regions, selected for inspection of the second ply.

In some embodiments of the graphical user interface, the identification of the first set of regions comprises an identification of a first subset of regions associated with a first level of performance and a second subset of regions associated with a second level of performance.

In some embodiments of the graphical user interface, the information area displaying the identification of the first set of regions comprises a schematic representation of a surface of the at least one ply segmented into a plurality of regions.

In some embodiments of the graphical user interface, the schematic representation comprises a labelling in each one of the plurality of regions corresponding to a performance indicator for the region.

### BRIEF DESCRIPTION OF THE DRAWINGS

Further features and advantages of the present invention will become apparent from the following detailed description, taken in combination with the appended drawings, in which:

FIG. 1 is a flowchart of an exemplary inspection method;

FIG. 2 is a flowchart of an exemplary method for determining a sampling plan;

FIG. 3a is a schematic of an exemplary performance map comprising two performance levels;

FIG. 3b is a schematic of an exemplary performance map comprising three performance levels;

FIG. 4 is a flowchart of another exemplary method for determining a sampling plan, including a feedback mechanism to update the sampling plan;

FIG. 5 is a flowchart of another exemplary method for determining a sampling plan, including a degradation analysis;

FIG. 6 is a flowchart of another exemplary method for determining a sampling plan, including a statistical validation;

FIG. 7 is a flowchart of an exemplary method for guiding inspection of a composite component;

FIG. 8a is an exemplary graphical user interface for guiding inspection of a composite component;

FIG. 8b is another exemplary graphical user interface with a schematic representation of a ply of a composite component;

FIG. 9 is a diagram of an exemplary system for determining a sampling plan in a network;

FIG. 10 is a block diagram of a set of exemplary applications running on the processor of the system of FIG. 9;

FIG. 11 is a block diagram of an exemplary sampling plan module;

FIG. 12 is a block diagram of an exemplary degradation analysis module; and

FIG. 13 is a block diagram of an exemplary statistical validation module.

It will be noted that throughout the appended drawings, like features are identified by like reference numerals.

### DETAILED DESCRIPTION

Composite components (or materials) are made from two or more constituent materials with significantly different physical or chemical properties. When combined, they produce a component with characteristics different from the individual materials, with the aim of using the benefit of both. Automated Fiber Placement (AFP) machines are used for the manufacture of such composite components, by laying fiber strips (tows) along a mold in multiple layers in order to create a composite component having the shape of the mold. The fiber strips are placed along the mold in accordance with fiber laying trajectories that are input into the AFP machine to create a given component in accordance with a set of design parameters.

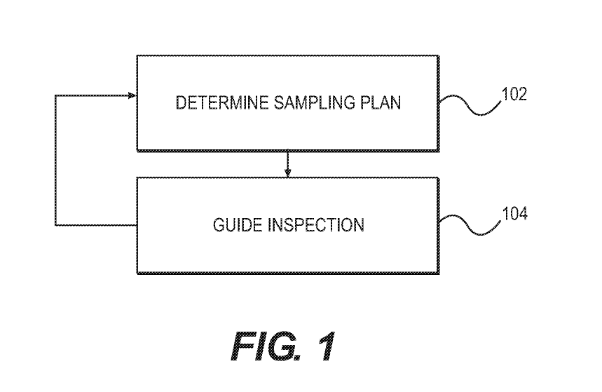

Referring to FIG. 1, an exemplary method for inspecting a composite component manufactured using an automated manufacturing process will be described. For illustrative purposes, the process described is an Automated Fiber Placement (AFP) process. The composite component may comprise various materials, such as but not limited to cements, concrete, reinforced plastics, metal composites and ceramic composites. For example, the composite component may be composed of composite fiber-reinforced plastics. The composite component may be used for various applications, including but not limited to buildings, bridges, spacecrafts, aircrafts, watercrafts, land vehicles including railway vehicles, and structures such as wind turbine blades, swimming pool panels, bathtubs, storage tanks, and counter tops.

FIG. 1 illustrates a dynamic method for performing sampling inspection. The component comprises multiple plies and each ply may be inspected separately. Each ply comprises multiple fibers (or tows). In a first step, a sampling plan is determined 102 using a statistical analysis of at least one component. Inspection of subsequent components is then guided 104 using the sampling plan. Results from the inspection may be used to update and/or modify the sampling plan 102 in a feedback loop.

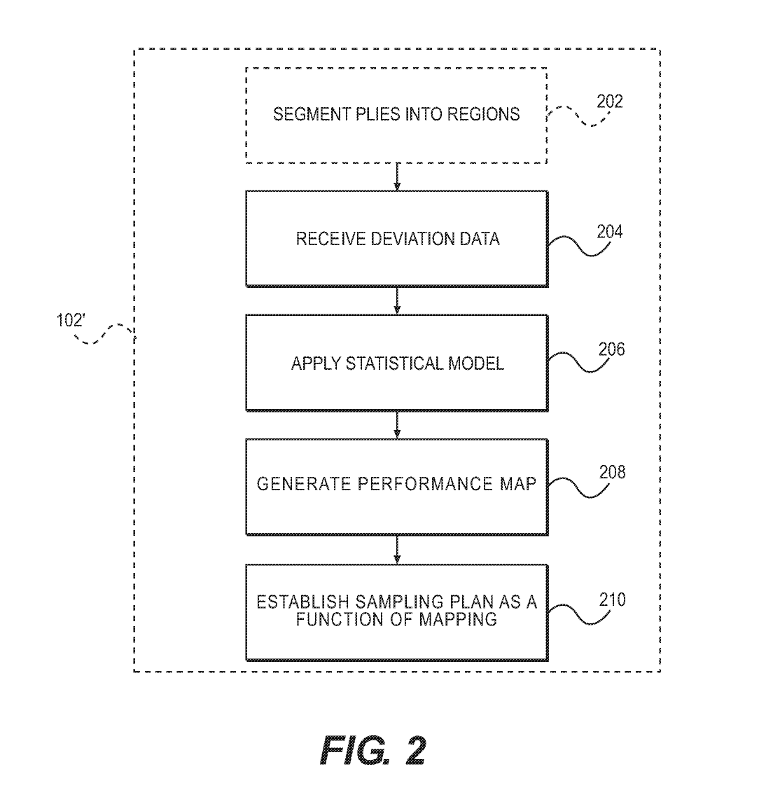

Turning to FIG. 2, there is illustrated a first embodiment 102′ for determining a sampling plan. The sampling plan may be established for the examination of a single ply one or more components or a plurality of plies of one or more components. The example herein illustrates applying the method to each ply of a composite component. Each ply of the composite component is segmented into a plurality of regions 202, each region comprising a subset of the fibers. The regions may be of a uniform shape, such as squares, rectangles, or circles, and may be of a same size. Alternatively, the regions may be of varying shapes and/or varying sizes. The shapes may be symmetrical, non-symmetrical, uniform, or non-uniform. Segmentation may be performed as a function of one or more characteristics of the composite component, using one or more considerations, such as the shape and/or design of the component. Alternatively, the size of the composite component is considered and segmentation is performed as a function of a desired number of regions of a desired size. In some embodiments, regions are bands that stretch across the component and each region is set to comprise a given number of fibers. For example, a component having 42 plies may have 100 bands per ply, and 16 fibers per band. As the layout of fibers may change from ply to ply, so may the segmenting of regions thereon. Other segmenting strategies will be readily understood by those skilled in the art.

In some embodiments, the plies have already been segmented and the method begins when deviation data is received 204 for all regions of a ply of at least one composite component. Alternatively, the deviation data may be received for all regions of all plies of at least one composite component. Deviation data corresponds to the deviation of a measured value from a nominal value for a given fiber. For each region, at least one fiber is measured and the difference between the measured value and the nominal value corresponds to a deviation value. The deviation data is thus the set of deviation values for all regions of the ply. In some embodiments, receiving deviation data 204 comprises receiving measurement data of the measured fibers and determining the deviation data from the measurement data. In some embodiments, only a subset of the fibers of each region are measured in order to obtain the deviation data. For example, one in four fibers or one in three fibers of a region are measured. In other embodiments, all of the fibers of each region are measured. A greater number of fibers measured per region will provide a higher reliability for the sampling plan. Higher reliability may also be obtained by using more than one component to establish the sampling plan, such as two or three components, with the results being averaged together.

Once the deviation data is received 204, a statistical model is applied 206 to the data. In some embodiments, applying a statistical model comprises generating a histogram from the deviation data and applying a Gaussian function to obtain a normal distribution. The normal distribution may be used to determine statistically the probability that the dimensional measurements of an unacceptable number of fibers within a given region will fall outside of a desired tolerance. This probability may then be used as a performance indicator. For example, the performance indicator may be whether the probability falls above or below a given threshold. In this example, two performance levels are provided, namely regions having a probability below the threshold are said to be compliant and regions having a probability above the threshold are said to be non-compliant. The threshold may be set to any desired level, such as 5%, 1%, 0.25%, etc. In some embodiments, the threshold is set to 0.27%. In another example, a process performance index such as Pₚₖ from Six Sigma quality methodology is used as a performance indicator. The process performance index may be compared to a threshold, such as 1.00 or 0.8, and values falling below the threshold are said to be non-compliant while values equal to or above the threshold are said to be compliant. Other known performance indicators may be used to represent the statistical probabilities generated by the normal distribution.

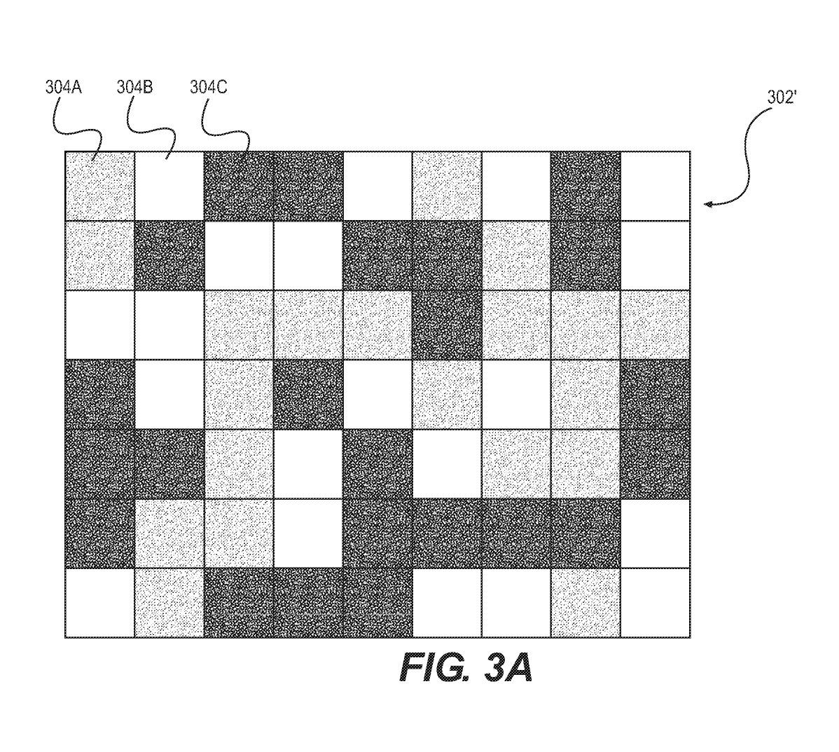

A performance map may be generated 208 using the performance indicators. The performance map correlates each region of a ply with its associated performance level. In some embodiments, the performance map may replicate the surface topography of a ply with each region identified according to its performance level. FIGS. 3a and 3b are examples of performance maps 302′, 302″ using two and three performance levels, respectively. In this example, the regions are color-coded according to their performance levels. In FIG. 3a, the performance map 302′ comprises light gray regions 304a that are compliant and black regions 304c that are non-compliant. White regions 304b are areas of the ply without any fibers. In FIG. 3b, the performance map 302″ also comprises dark gray regions 304d that are passable or intermediate. Passable regions 304d are regions that fall within a narrow quality level that is close to being compliant but not quite. For example, using a percentage criteria as a performance indicator, the performance map 302″ may correspond to the following:

TABLE 1

| | Performance |
|---|---|
| Region | indicator (PI) |
| Light gray | PI < 0.27% |
| Dark gray | 0.27% < PI < 1.6% |
| Black | PI > 1.6% |

Referring back to FIG. 2, once the performance map has been generated 208, the sampling plan is established 210 as a function of the mapping of performance indicators. In some embodiments, establishing the sampling plan 210 comprises assigning a sampling criteria to each of the performance indicators. The sampling criteria is indicative of how many regions of one or more plies from one or more subsequent components having a given performance indicator are to be inspected. In some embodiments, the sampling criteria corresponds to a given percentage of regions having a given performance indicator. For example, using the example from table 1, the sampling criteria may be set to 100% of the black regions, 50% of the dark gray regions, and 0% of the light gray regions for a ply of a subsequent component. In some embodiments, a small sampling of the light gray regions may be selected for inspection, such as 7%. Other sampling criteria may also be used. In addition, the sampling criteria may comprise a combination of a plurality of criterion, such as 50% of the dark regions of a ply of a subsequent component, at least 10% of the 50% not having been inspected in a corresponding ply of a previous component. In another example, the sampling criteria may refer to 50% of the dark gray regions of a ply, at least 5% of the 50% being adjacent to a black region. Various factors may be used as sampling criteria, such as proximity to an edge, known problematic areas on a component, etc.

The sampling criteria may refer to a number of regions to be inspected from a single ply, a plurality of plies, an entire component, or a plurality of components. For example, the sampling criteria may be set to 50% of the dark gray regions of every set of two plies. This means that if there are 10 dark gray regions on a first ply and 8 dark grey regions on a second ply, then 50% of the 18 dark gray regions, i.e. 9 dark gray regions, are to be inspected. The 50% may be broken down in various ways, such as 4 on the first ply and 5 on the second ply, or 6 and 3, etc. Similarly, if the sampling criteria is applicable to an entire component, then 50% of the dark grey regions from all of the plies of the component are to be inspected, whereby the sum of the number of inspected regions from each ply corresponds to 50% of the total number of dark grey regions for the component. The sampling criteria may be constant for all plies of a component or it may vary from ply to ply. The sampling criteria may be constant for a plurality of components or it may vary from component to component. Therefore, establishing a sampling plan may comprise establishing different sampling plans for different plies.

In some embodiments, establishing the sampling plan 210 also comprises selecting regions for inspection as a function of the performance indicators and the sampling criteria. This selection may be performed randomly within the parameters of the sampling criteria, or it may be performed non-randomly. An example of random selection comprises choosing any one of the 18 dark gray regions of a ply in order to meet the sampling criteria of 50% of dark regions of the ply. An example of non-random selection comprises a targeted selection from among the 18 dark gray regions, whether the targeted selection is performed automatically or manually. The random selection may also be performed automatically or manually. Various selection algorithms may be devised to select the regions as a function of the performance indicators and the sampling criteria. It may be desired to maintain a constant sampling criteria, such as 50% of the dark gray regions, while ensuring that different ones of the dark grey regions are inspected on consecutive plies or consecutive components. The selection algorithm may be applied to different quantities of regions, such as 7%, 59%, 81%, etc., and to any one of plies, components, and batches of components.

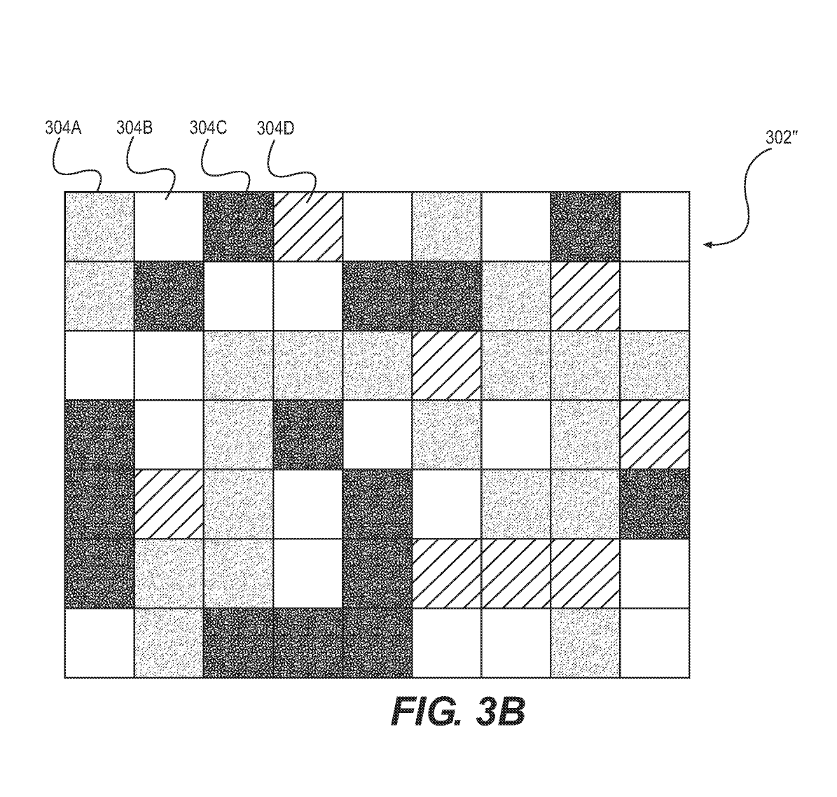

Once established, the sampling plan for a given ply or plurality of plies may be used to inspect corresponding plies of one or more subsequent components. Only selected regions of subsequent components are inspected, as per the sampling plan. Regions that are inspected and do not meet the required tolerances may be repaired. Repaired regions may be measured again and used to update the sampling plan. This embodiment 102″ is illustrated in FIG. 4, whereby updated deviation data 212 is received and a new statistical model is applied 206 to the updated deviation data to obtain updated performance indicators for the repaired regions. An updated performance map may be generated 208 with the updated performance indicators.

In some embodiments, the feedback loop may be used early on in the inspection process to validate the performance map. For example, if one or more regions from the map are labeled as compliant but once measured they are found to be non-compliant, this may be an indication that not enough components were used to generate the initial performance map and the performance map may need to be updated or regenerated using more components. Similarly, if one or more regions from the map are labeled as non-compliant but once measured they are found to be compliant, the performance map may be updated accordingly in order to properly reflect the set of components.

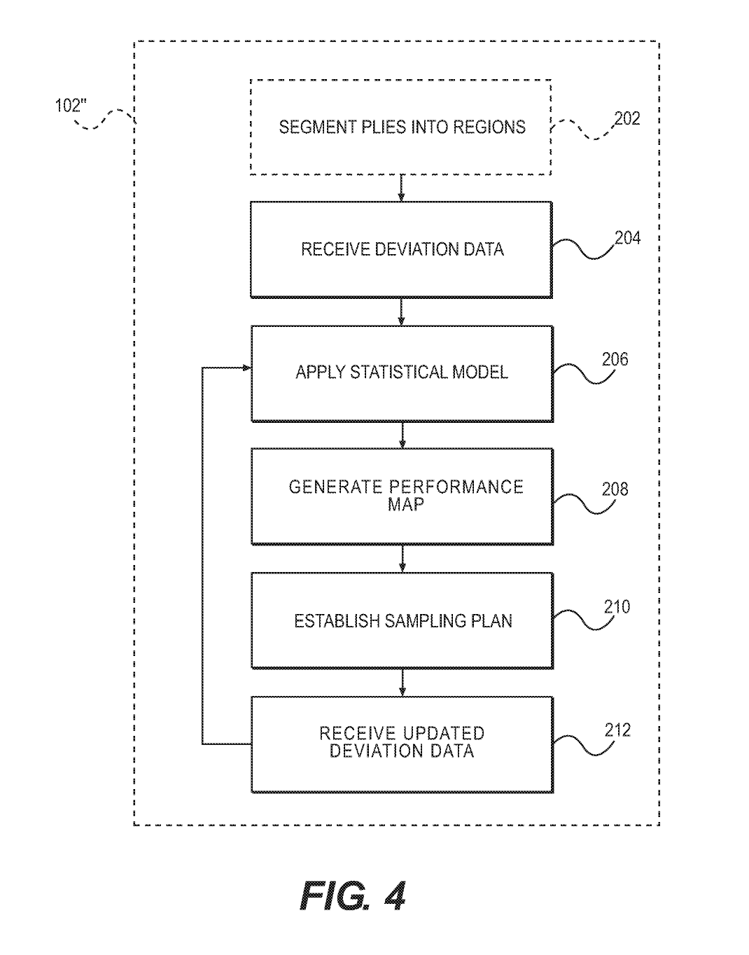

In some embodiments, the feedback loop may be used to ensure that the fabrication process is not degrading. Process degradation sometimes occurs when equipment used in automated fabrication processes become decalibrated over time or due to a repair or modification made to the robot. FIG. 5 illustrates an exemplary embodiment 102″ of determining a sampling plan which includes performing a degradation analysis 300. When a new statistical model is applied to updated deviation data, the updated performance indicators may be compared to the original performance indicators 302. An analysis of variance (ANOVA) may be used to perform the comparison using multiple statistical models. If the comparison shows that a performance level of a given region has decreased, this may be an indication of process degradation. Regions adjacent to the region having a decreased performance level may be selected for inspection 304. Deviation data for the adjacent regions are received 306 and used to quantify the degradation of the manufacturing process 308. In some embodiments, an alarm may be triggered when the process degradation reaches a predetermined threshold.

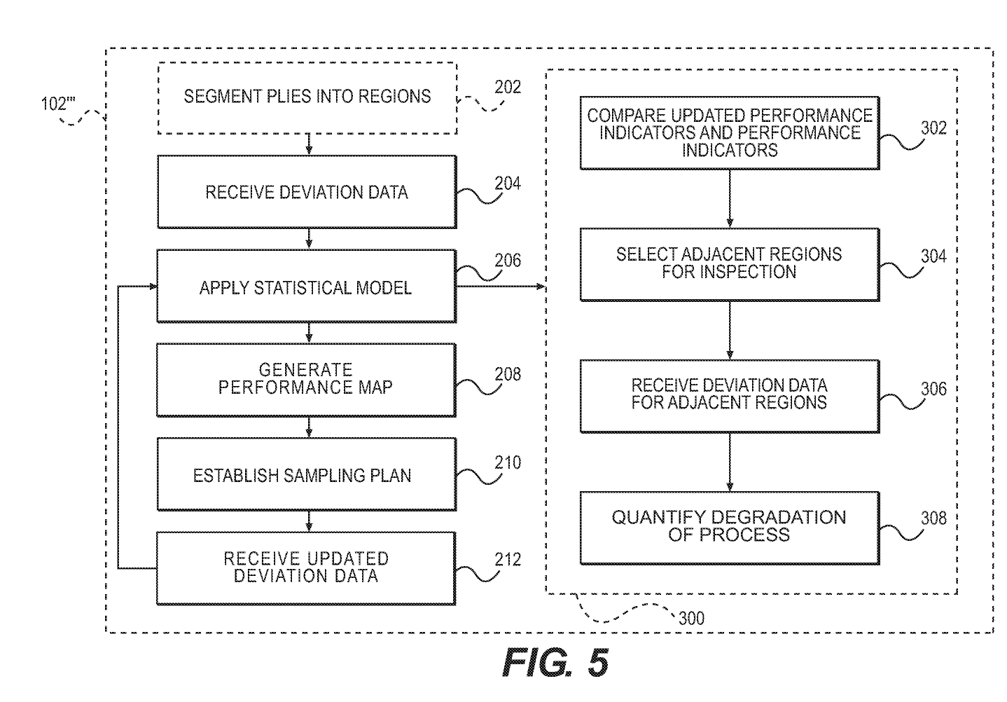

If the fabrication process is interrupted for any reason, such as for maintenance or repair of the equipment, it may be useful to perform a statistical validation to ensure that the previously applied statistical model is still valid. FIG. 6 illustrates an exemplary embodiment 102″″ of determining a sampling plan which includes performing a statistical validation 400. A process modification signal is received to indicate that an event has occurred, causing a possible change in the process. A determination is made as to whether the statistical model is affected by the event 404. This determination may be done, for example, by comparing a statistical model for a new set of deviation data to the statistical model of a previous set of deviation data. If an equivalence analysis shows that the statistical models are not sufficiently similar, the previous performance map may be replaced with a new performance map using an updated statistical model 406. In some embodiments, the statistical model is automatically updated using a new set of deviation data as soon as the process modification signal is received 402, without performing a comparison.

Although illustrated separately, in some embodiments the method of determining a sampling plan 102 comprises both the degradation analysis 300 and the statistical validation 400.

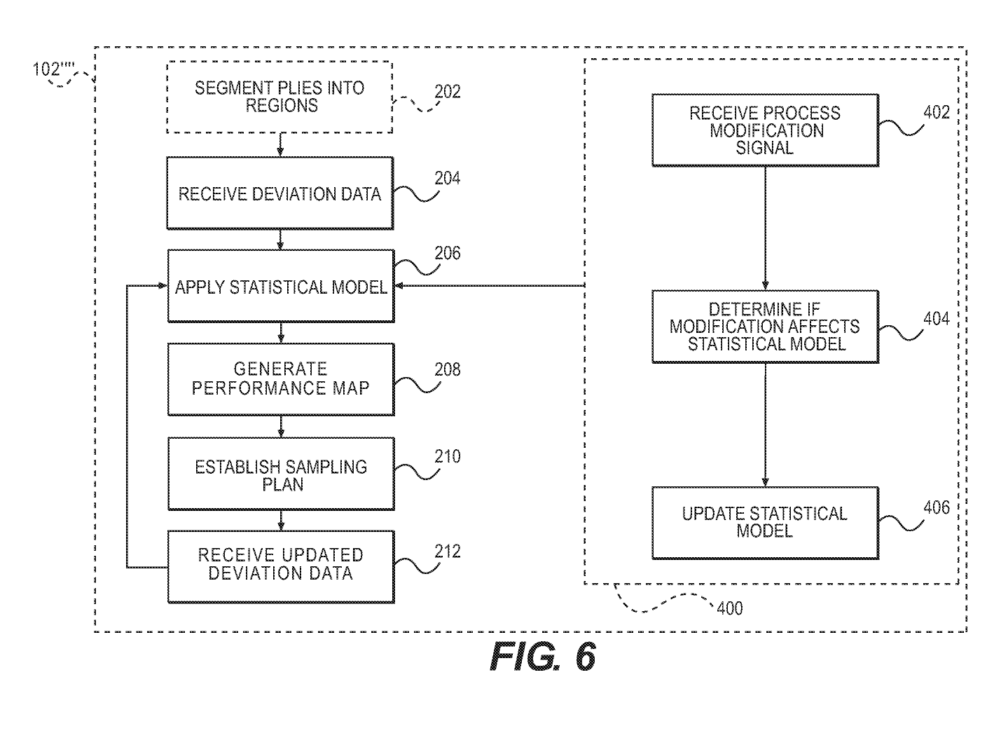

FIG. 7 is a flowchart of an exemplary method for guiding inspection of at least one ply of a composite component 104. In a first step 502, a mapping of performance indicators and corresponding sampling criteria are received for the at least one ply. From the received data, regions for inspection may be selected 504. More specifically, an algorithm may be applied to the mapping and the sampling criteria in order to generate an identification of selected regions. The selected regions for inspection of the at least one ply are then displayed on a graphical user interface (GUI). In some embodiments, displaying selected regions for inspection comprises displaying a graphical identification of the selected regions. Alternatively, the selected regions may be identified using a coordinate system that is mapped onto the surface of a ply. The method may also comprise receiving, via a user actionable object on the GUI, an indication that the selected regions for inspection have been inspected. In some embodiments, this may cause the GUI to update the display to provide further information, either for continued inspection of a same ply or for inspection of a subsequent ply or a subsequent component.

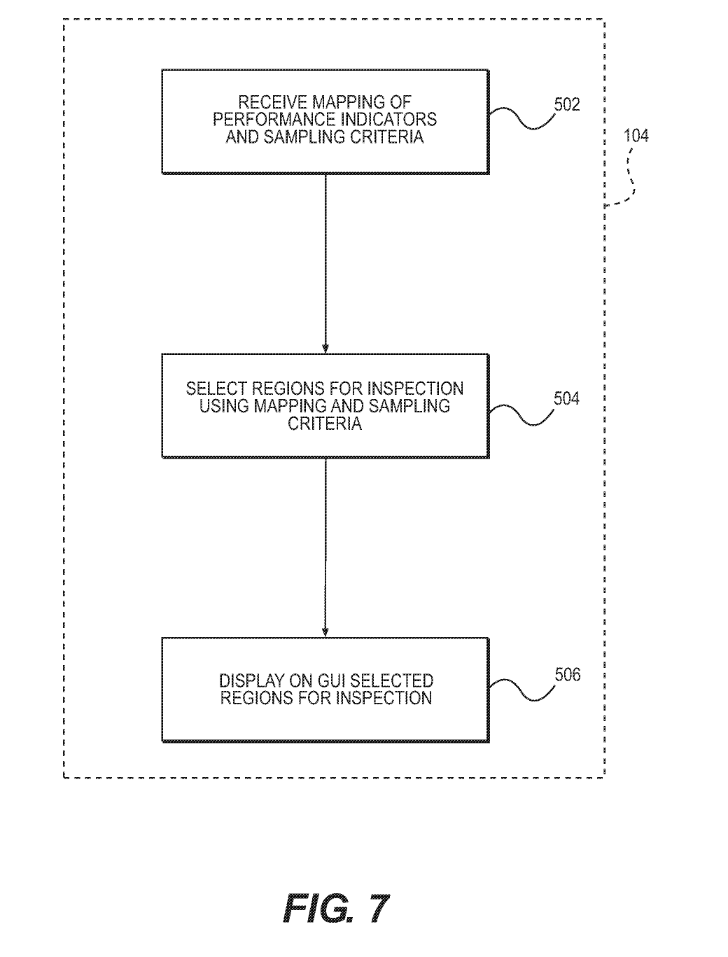

Referring to FIG. 8a, there is illustrated an exemplary embodiment of a GUI 602 for guiding inspection of the composite component. The GUI 602 comprises an information area 604 for displaying an identification of one or more selected regions for inspection. In this example, a text box 608 is provided for displaying one or more selected region(s) for inspection, using some form of region identifier. An actionable object 606 is also provided. The actionable object 606 is any graphical control element that invokes an action when activated by a user. It is selectable by a user for providing confirmation that the selected region(s) of a given ply identified in information area 604 have been inspected. The actionable object 606 may take various forms, such as a button, a slider, an icon, a list box, a spinner, a drop-down list, a link, a tab, a scroll bar, and/or any combination thereof. In this example, the actionable object 606 comprises two elements, a “next” button 610 to confirm that the region(s) displayed in the text box 608 has/have been inspected and a “done” button 612 to confirm that inspection is complete or that all regions of a ply/component/batch have been inspected. Actuation of the “next” button 610, may be operative for causing the text box 608 to display a subsequent region or, in the case where all the selected regions of a given ply are displayed simultaneously, to display the selected regions of a subsequent ply. More or less elements may be used for the actionable object 606.

Another embodiment for the GUI 602 is illustrated in FIG. 8b. In this example, the information area 604 is provided with a schematic representation 600 of a surface of a ply segmented into a plurality of regions. Each region is identified with a performance level, which in this case is a shading in a square representing a region, but could be another visual cue. In addition to, or instead of, the text box 608 with the selected region(s) for inspection identified, a graphical element 618 is used to represent the selected region(s) of a ply that is/are to be currently inspected. Alternatively, all regions from the ply that are to be inspected may be concurrently identified with a graphical element 618 and the text box 608 is used to simultaneously or sequentially display the regions that are to be inspected. A “next region” button 613 may be used to cause the textbox 608 to display a next region to inspect, in the case where the regions are identified sequentially. A “next ply” 614 button may be used to update the information area with selected regions for a next ply. A “next component” 616 button may be used to update the information area with the selected regions for inspection of a subsequent component.

Additional information may be provided in the information area 604 of the GUI 602. For example, the performance indicators themselves may be provided in a legend format next to the schematic representation of the ply. The sampling criteria associated with each level of performance indicator may also be provided. Identification data for the ply and/or component and/or batch under inspection may be provided.

In some embodiments, the method of determining a sampling plan 102 is used in combination with the method for guiding inspection of a composite component. For example, deviation data is received for all of the regions of at least one ply 204, a statistical model is applied to the deviation data 206 and a performance map is generated 208. A sampling plan is established as a function of the mapping 210. The method may further comprise assigning sampling criteria to each of the performance indicators. The sampling plan, which comprises the mapping of performance indicators and the sampling criteria, is received 502 and regions for inspection are selected 504. The selected regions are displayed on the GUI 506. The two methods may be performed by a same entity or by separate entities, as will be explained in more detail below.

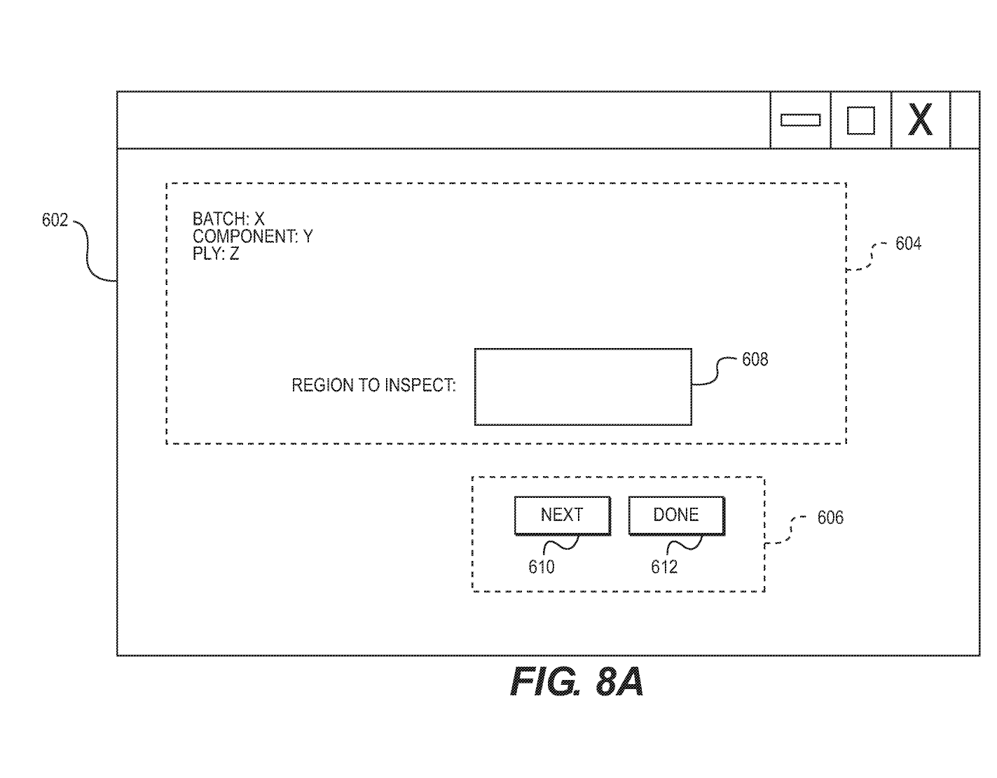

FIG. 9 illustrates an exemplary system 701 for determining a sampling plan for composite component inspection. In the embodiment illustrated, the system 701 is adapted to be accessed by a plurality of devices 710 via a wireless network 708, such as the Internet, a cellular network, Wi-Fi, or others known to those skilled in the art. The devices 710 may comprise any device, such as a laptop computer, a personal digital assistant (PDA), a smartphone, or the like, adapted to communicate over the wireless network 708. Alternatively, the system 701 may be provided in part or in its entirety directly on devices 710, as a native application or a web application. It should be understood that cloud computing may also be used such that the system 701 is provided partially or entirely in the cloud. In some embodiments, the application 706a may be downloaded directly onto devices 710 and application 706n communicates with application 706a via the network 708.

The system 701 may reside on one or more server(s) 700. For example, a series of servers corresponding to a web server, an application server, and a database server may be used. These servers are all represented by server 700 in FIG. 9. The system 701 may comprise, amongst other things, a processor 704 in data communication with a memory 702 and having a plurality of applications 706a, . . . , 706n running thereon. The processor 704 may access the memory 702 to retrieve data. The processor 704 may be any device that can perform operations on data. Examples are a central processing unit (CPU), a microprocessor, and a front-end processor. The applications 706a, . . . , 706n are coupled to the processor 704 and configured to perform various tasks as explained below in more detail. It should be understood that while the applications 706a, 706n presented herein are illustrated and described as separate entities, they may be combined or separated in a variety of ways. It should be understood that an operating system (not shown) may be used as an intermediary between the processor 704 and the applications 706a, . . . , 706n.

The memory 702 accessible by the processor 704 may receive and store data, such as deviation data, deviation values, measurement values, statistical models, performance indicators, performance maps, etc. The memory 702 may be a main memory, such as a high speed Random Access Memory (RAM), or an auxiliary storage unit, such as a hard disk or flash memory. The memory 702 may be any other type of memory, such as a Read-Only Memory (ROM), Erasable Programmable Read-Only Memory (EPROM), or optical storage media such as a videodisc and a compact disc.

One or more databases 712 may be integrated directly into the memory 702 or may be provided separately therefrom and remotely from the server 700 (as illustrated). In the case of a remote access to the databases 712, access may occur via any type of network 708, as indicated above. The databases 712 may also be accessed through an alternative wireless network or through a wired connection. The databases 712 described herein may be provided as collections of data or information organized for rapid search and retrieval by a computer. The databases 712 may be structured to facilitate storage, retrieval, modification, and deletion of data in conjunction with various data-processing operations. The databases 712 may consist of a file or sets of files that can be broken down into records, each of which consists of one or more fields. Database information may be retrieved through queries using keywords and sorting commands, in order to rapidly search, rearrange, group, and select the field. The databases 712 may be any organization of data on a data storage medium, such as one or more servers.

In one embodiment, the databases 712 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Alternatively, any known communication protocols that enable devices within a computer network to exchange information may be used. Examples of protocols are as follows: IP (Internet Protocol), UDP (User Datagram Protocol), TOP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

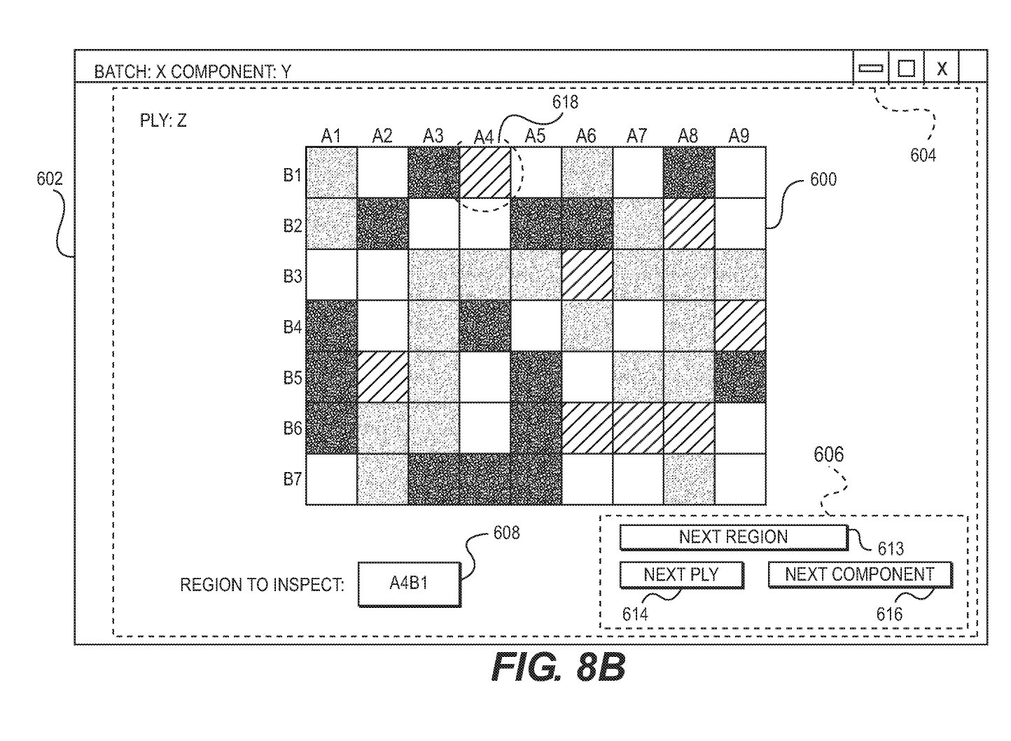

Referring now to FIG. 10, there is illustrated an exemplary block diagram of application 706a, for determining a sampling plan for composite component inspection. A sampling plan module 804 receives deviation data and outputs selected regions for inspection. The sampling plan module 804 may also exchange data with a statistical validation module 802 and/or a degradation analysis module 806, which may form part of the system 701 but be separate from application 706a, as illustrated. Alternatively, the statistical validation module 802 and/or a degradation analysis module 806 may form part of application 706a. Also alternatively, the statistical validation module 802 and/or a degradation analysis module 806 may be remote from system 701, and data may be exchanged via network 708.

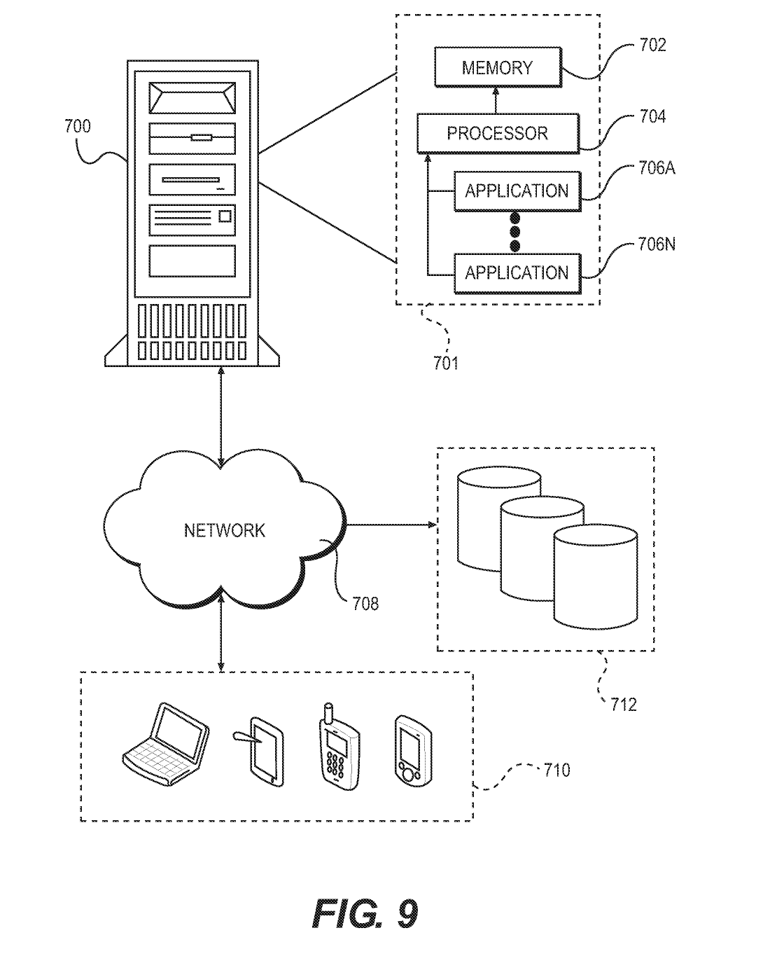

FIG. 11 illustrates an exemplary embodiment of the sampling plan module 804. A segmenting module 902 is configured to segment each one of the plies into a plurality of regions, each region comprising a subset of the fibers of a ply. A statistical modelling module 904 is configured to receive deviation data and apply a statistical model thereto to obtain a performance indicator for each region of a ply. A performance mapping module 906 generates a mapping of performance indicators for all regions of a ply. A region selection module 908 selects regions of each ply for inspection as a function of the performance indicators in accordance with a sampling criteria. The selected regions may be output by the sampling plan module 804. Alternatively, the selected regions may be provided to a GUI module 910 configured to display on a graphical user interface the selected regions for inspection. The GUI module 910 may also be provided separately from the sampling plan module 804, as a separate application 706b running on processor 704 or remotely therefrom.

In some embodiments, the statistical modelling module 904 receives measurement data and is configured to determine deviation data from the measurement data by comparing the measurement data to nominal data. The nominal data may be stored in the memory 702 or in the remote databases 712.

In some embodiments, the sampling plan module 804 is configured to receive deviation data from a plurality of components and generate a performance map resulting from averaged performance indicators.

In some embodiments, the statistical modelling module 904 receives updated deviation data from the inspection of the selected regions and applies the statistical model to the updated deviation data to obtain updated performance indicators for the selected regions. The performance mapping module 906 is configured to generate an updated mapping of performance indicators with the updated performance indicators.

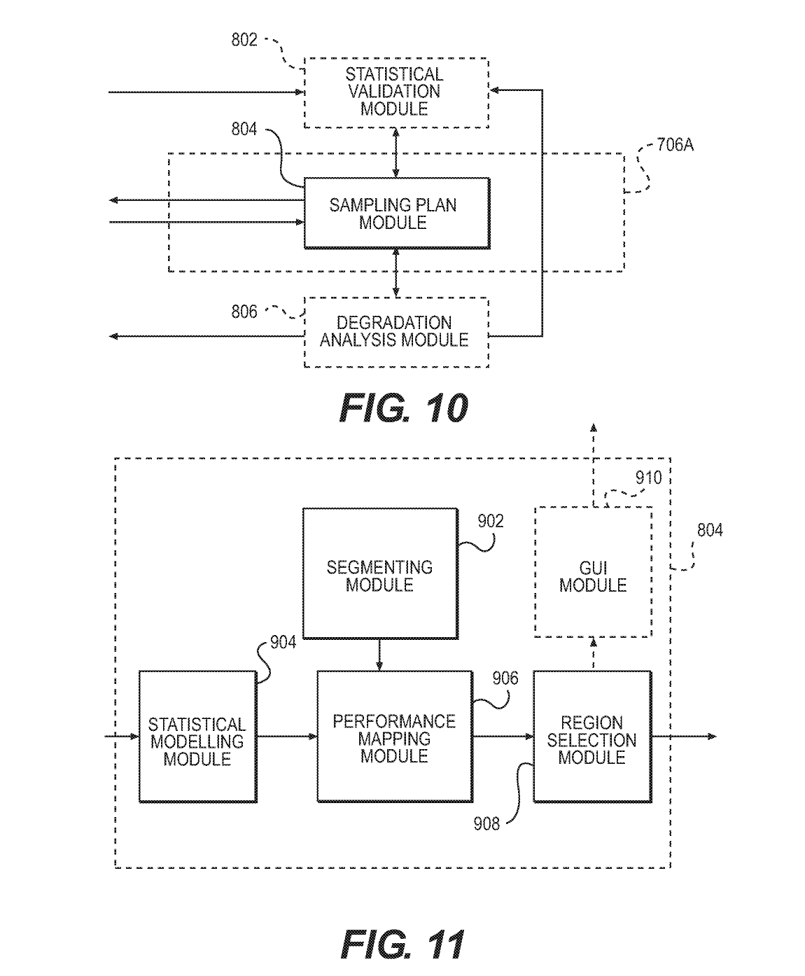

FIG. 12 is an exemplary embodiment of the degradation analysis module 806, for monitoring and quantifying a degradation of the manufacturing process. A comparison module 1002 is configured to receive updated performance indicators for selected regions and compare them with the previous performance indicators. If the comparison shows a decrease in performance for a given region, the region selection module 908 is instructed to select for inspection regions adjacent to the region having a decreased performance. The deviation data for the adjacent regions is received by a degradation quantification module 1006 and used to quantify the degradation, which is output by the degradation analysis module 806. In some embodiments, the degradation quantification module 1006 may be configured to trigger an alarm if the process degrades beyond a predetermined threshold.

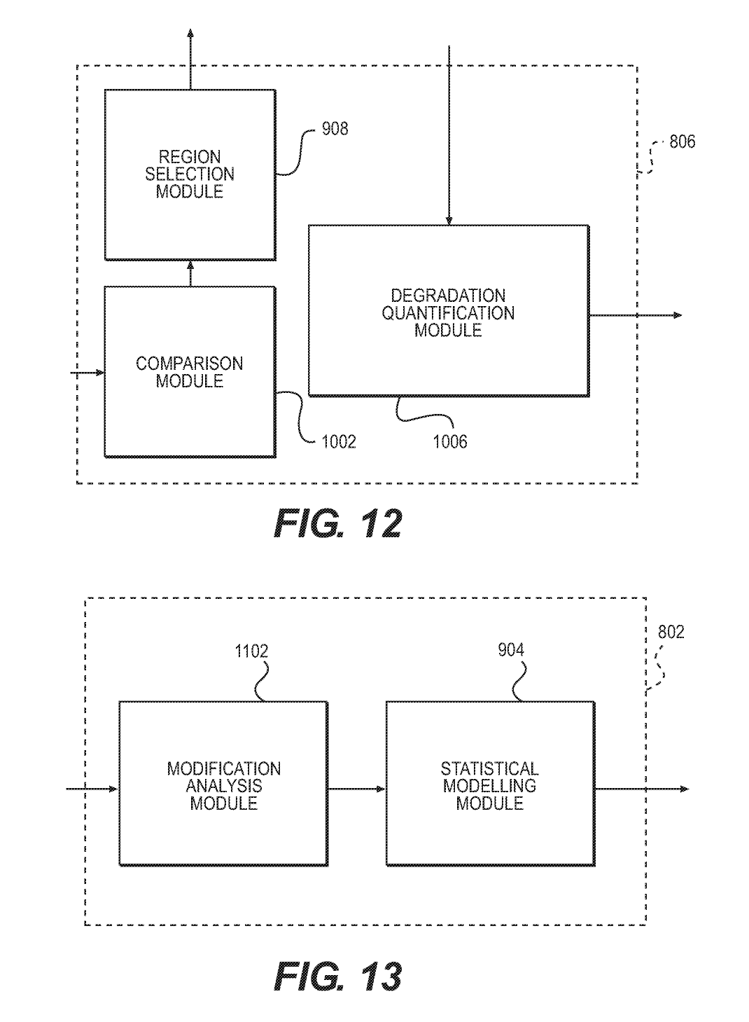

FIG. 13 is an exemplary embodiment of the statistical validation module 802, for validating the statistical model applied to the deviation data in case of an event occurring within the fabrication process. The statistical validation module 802 may comprise a modification analysis module 1102 configured to receive a signal indicative of the occurrence of an event, such as a repair or maintenance of equipment used in the manufacturing process. In some embodiments, the modification analysis module 1102 performs a comparison between a new statistical model based on updated deviation data and a previous statistical model. A signal is sent to the statistical modelling module 904 in case of a discrepancy between the two models in order to reset the sampling plan module 804. The modification analysis module 1102 may also be configured to automatically send a signal to the statistical modelling module 904 when a signal indicative of the occurrence of an event is received.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The statistical validation module 802, the sampling plan module 804, and the degradation analysis module 806 may share hardware and/or software resources. The structure illustrated is thus provided for efficiency of teaching the present embodiment.

It should be noted that the present invention can be carried out as a method, can be embodied in a system, or can be provided on a computer readable medium having stored thereon program code executable by a processor. The embodiments of the invention described above are intended to be exemplary only. The scope of the invention is therefore intended to be limited solely by the scope of the appended claims.

1. A computer-implemented method for determining a sampling plan for inspection of composite components, the composite components each comprising at least one ply comprising a plurality of regions, each one of the regions having a plurality of fibers, the method comprising:
receiving deviation data for all of the regions of at least one ply of at least a first composite component, the deviation data corresponding to a deviation of a measured value from a nominal value for a given fiber;
applying a statistical model to the deviation data to obtain a performance indicator for each one of the regions and generating a mapping of performance indicators for the at least one ply; and
establishing the sampling plan for inspection of the at least one ply of at least one subsequent composite component as a function of the mapping of performance indicators.

2. The method of claim 1, wherein establishing the sampling plan comprises assigning a sampling criteria to each of the performance indicators, the sampling criteria being indicative of how many regions having a given performance indicator are to be inspected.

3. The method of claim 2, wherein the sampling criteria is indicative of how many regions from one of the at least one ply, the at least one subsequent composite component, and a plurality of subsequent composite components, are to be inspected.

4. The method of claim 2, wherein establishing the sampling plan comprises establishing a first sampling plan for a first ply as a function of a first sampling criteria, and establishing a second sampling plan for a second ply as a function of a second sampling criteria different from the first sampling criteria.

5. The method of claim 2, wherein establishing the sampling plan comprises establishing a first sampling plan for a first subsequent component as a function of a first sampling criteria, and establishing a second sampling plan for a second subsequent component as a function of a second sampling criteria different from the first sampling criteria.

6. The method of claim 2, wherein establishing the sampling plan further comprises selecting regions for inspection as a function of the performance indicators and the sampling criteria.

7. The method of claim 6, wherein applying a statistical model comprises using at least three levels of performance indicators, the at least three levels comprising a lowest level of performance, an intermediate level of performance, and a highest level of performance.

8. The method of claim 7, wherein selecting regions comprises selecting all regions of the lowest level and selecting some regions of the intermediate level.

9. The method of claim 8, wherein selecting regions comprises selecting a number of regions of the highest level that is less than a number of selected regions of the intermediate level.

10. The method of claim 6, further comprising:
receiving updated deviation data of the selected regions from inspection of the at least one subsequent composite component;
applying the statistical model to the updated deviation data of the selected regions to obtain updated performance indicators for the selected regions; and
generating an updated mapping of performance indicators with the updated performance indicators.

11. The method of claim 10, further comprising:
comparing the updated performance indicators of the selected regions with the performance indicators for corresponding regions;
selecting for inspection regions adjacent to a selected region for which the updated performance indicator is lower than the performance indicator;
receiving deviation data for the adjacent regions; and
quantifying a degradation of a manufacturing process using the deviation data from the adjacent regions.

12. The method of claim 1, wherein receiving deviation data comprises receiving measurement data for at least one of the fibers of a region, for all regions of the at least one ply, and determining the deviation data from the measurement data.

13. The method of claim 1, further comprising receiving a signal indicative of a change in a manufacturing process of the composite components, and updating the statistical model to reflect the change.

14. The method of claim 13, wherein the signal is indicative of a maintenance of equipment used in the manufacturing process.

15. The method of claim 1, wherein receiving deviation data for all of the regions of the at least one ply of at least a first composite component comprises receiving deviation data for a plurality of composite components, and wherein mapping the performance indicators comprises mapping averaged performance indicators for the plurality of composite components.

16. The method of claim 1, wherein the deviation data corresponds to measurements of at least one of the fibers of a given region.

17. A system for determining a sampling plan for inspection of composite components, the composite components each comprising at least one ply comprising a plurality of regions, each one of the regions having a plurality of fibers, the system comprising:
a memory;
a processor; and
at least one application stored in the memory and executable by the processor for:
receiving deviation data for all of the regions of at least one ply of at least a first composite component, the deviation data corresponding to a deviation of a measured value from a nominal value for a given fiber;
applying a statistical model to the deviation data to obtain a performance indicator for each one of the regions and generating a mapping of performance indicators for the at least one ply; and
establishing the sampling plan for inspection of the at least one ply of at least one subsequent composite component as a function of the mapping of performance indicators.

18. The system of claim 1, wherein establishing the sampling plan comprises assigning a sampling criteria to each of the performance indicators, the sampling criteria being indicative of how many regions having a given performance indicator are to be inspected.

19. The system of claim 18, wherein the sampling criteria is indicative of how many regions from one of the at least one ply, the at least one subsequent composite component, and a plurality of subsequent composite components, are to be inspected.

20. The system of claim 18, wherein establishing the sampling plan comprises establishing a first sampling plan for a first ply as a function of a first sampling criteria, and establishing a second sampling plan for a second ply as a function of a second sampling criteria different from the first sampling criteria.

21. The system of claim 18, wherein establishing the sampling plan comprises establishing a first sampling plan for a first subsequent component as a function of a first sampling criteria, and establishing a second sampling plan for a second subsequent component as a function of a second sampling criteria different from the first sampling criteria.

22. The system of claim 18, wherein establishing the sampling plan further comprises selecting regions for inspection as a function of the performance indicators and the sampling criteria.

23. The system of claim 22, wherein applying a statistical model comprises using at least three levels of performance indicators, the at least three levels comprising a lowest level of performance, an intermediate level of performance, and a highest level of performance.

24. The system of claim 23, wherein selecting regions comprises selecting all regions of the lowest level and selecting some regions of the intermediate level.

25. The system of claim 24, wherein selecting regions comprises selecting a number of regions of the highest level that is less than a number of selected regions of the intermediate level.

26.-32. (canceled)

33. A computer readable medium having stored thereon program code executable by a processor for determining a sampling plan for inspection of composite components, the composite components each comprising at least one ply comprising a plurality of regions, each one of the regions having a plurality of fibers, the program code executable for:
receiving deviation data for all of the regions of at least one ply of at least a first composite component, the deviation data corresponding to a deviation of a measured value from a nominal value for a given fiber;
applying a statistical model to the deviation data to obtain a performance indicator for each one of the regions and generating a mapping of performance indicators for the at least one ply; and
establishing the sampling plan for inspection of the at least one ply of at least one subsequent composite component as a function of the mapping of performance indicators.

34. A computer-implemented method for guiding inspection of at least one ply of a composite component, the method comprising:
receiving a mapping of performance indicators and a sampling criteria associated with the at least one ply, each one of the performance indicators corresponding to a region of the at least one ply, each region comprising a plurality of fibers, the sampling criteria being indicative of how many regions having a given performance indicator are to be inspected;
selecting regions of the at least one ply for inspection as a function of the performance indicators and the sampling criteria; and
displaying on a graphical user interface an identification of selected regions of the at least one ply for inspection.

35. The method of claim 34, wherein displaying on a graphical user interface selected regions for inspection comprises displaying a graphical identification of the selected regions of the at least one ply for inspection.

36. The method of claim 34, further comprising receiving, via a user actionable object on the graphical user interface, an indication that at least one selected region of the at least one ply for inspection has been inspected.

37. A graphical user interface for guiding inspection of a composite component having at least a first ply and a second ply, the graphical user interface comprising:
an information area displaying an identification of a first set of regions from the first ply, selected for inspection of the first ply; and
an actionable object responsive to user input for receiving confirmation that the first set of regions have been inspected;
wherein upon receipt of the confirmation, the information area is updated to display an identification of a second set of regions from the second ply different from the first set of regions, selected for inspection of the second ply.

38.-40. (canceled)
